(19) United States
(12) Patent Application Publication
(10) Pub. No.: US 2006/0080653 A1
(43) Pub. Date: Apr. 13, 2006

(54) Methods and systems for patch distribution

(75) Inventors: Bomani Siwatu, Seattle, WA (US); Robert Y. Oikawa, Redmond, WA (US); William J. Reid, Seattle, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/963,380

(22) Filed: Oct. 12, 2004

(51) Int. Cl. G06F 9/44

(52) U.S. Cl. 717/173

(57) ABSTRACT

In one aspect, a method for distributing a software patch to a plurality of customers includes downloading the software patch from at least one server to one of a number of kiosks located at public customer-accessible locations. In another aspect, a system for distributing a software patch includes kiosks located in public customer-accessible locations, and one or more servers configured to download the software patch to the kiosks. In another aspect, a method of updating a computer by installing a software patch includes traveling to a location of a kiosk, using a customer interface of the kiosk to create a copy of the software patch on at least one portable computer readable medium, transporting the at least one portable computer readable medium to a location of the computer, and installing the software patch from the at least one portable computer readable medium onto the computer.

### FIELD OF THE INVENTION

The present invention relates to distribution of software updates for computer systems.

### BACKGROUND OF THE INVENTION

Existing software programs, such as an operating system or productivity application, on a computer system often require updating. Updating is typically accomplished by executing a software patch on the computer system. A software patch can be used, for example, to upgrade an existing program to a newer version of the program, to remedy a security vulnerability of an existing program, to repair a damaged program, etc. Damage can be caused by, for example, a virus attack that exploits a pre-existing system, configuration, or software vulnerability. Thus, for example, a vendor of an existing program may produce software patches that overcome discovered security vulnerabilities in a networked computer system, remedy damage done by a virus, or improve performance and/or functionality of a pre-existing software program.

A widespread virus attack can damage a large number of computers utilizing software of a vendor. For example, a virus that attacks the operating system of computers utilizing a “WINDOWS” operating system (from Microsoft Corporation, Redmond, Wash.) can lead to thousands, or millions, of computer users that require assistance from Microsoft Corporation to remedy damage caused by the attack, and/or to update the operating system to eliminate a security vulnerability exploited by the virus.

### SUMMARY OF THE INVENTION

In one aspect, the invention features a method for distributing a software patch to customers of a software vendor. The method includes downloading the software patch from at least one server to a kiosk. The software patch includes software designed to modify at least one pre-existing software program. The kiosk is one of a number of kiosks located at public customer-accessible locations. The kiosks have a customer interface that, in part, enables the software patch to be transferred to a portable computer readable medium.

In a second aspect, the invention features a method for updating a computer by installing a software patch applicable to at least one software program previously installed on the computer. The method includes traveling to a location of a kiosk to obtain the patch via the kiosk. The software patch is stored in a medium accessible to the kiosk. The method also includes using a customer interface of the kiosk to create a copy of the software patch on a portable computer readable medium, transporting the portable computer readable medium to a location of the computer, and installing the software patch from the portable computer readable medium onto the computer.

In another aspect, the invention features a system for distributing a software patch. The system includes kiosks located in public customer-accessible locations. Each kiosk has a customer interface that enables the software patch to be transferred to a portable computer readable medium so that each customer can use at least one of the kiosks to create a copy of the software patch on the portable computer readable medium. The system also includes one or more servers configured to download the software patch to the kiosks.

### BRIEF DESCRIPTION OF THE DRAWINGS

FIG. 1 illustrates a flow diagram of top-level activities for distributing a software patch to a plurality of customers, in accordance with one embodiment of the present invention;

FIG. 2 illustrates a flow diagram of top-level activities for updating a computer to install a software patch applicable to at least one software program previously installed on the computer, in accordance with one embodiment of the present invention; and

FIG. 3 illustrates a system for distributing a software patch to a plurality of customers, in accordance with one embodiment of the present invention.

### DETAILED DESCRIPTION

The phrase “software patch” herein refers to a publicly released update to a software product that typically occurs between service pack releases. Typically, software updates are created and released expeditiously, in reaction to a specific issue. Many software updates are released to correct security vulnerabilities. Software updates also respond to other issues, such as improving performance, extending product functionality, and facilitating product interactions with newly released hardware or software.

Some examples of a software update include, but are not limited to, those that provide one or more of the following fixes: a fix that addresses a security issue for a product (often called a security patch); a fix that addresses a critical, security related issue for a product (often called a critical update); a fix that addresses a non-critical, non-security related issue for a product, e.g., a patch that adds new features and/or functionality (often called an update); and a cumulative set of security patches, critical updates, and updates packaged together for easy deployment (often called an update rollup.) A cumulative set of patches can contain, for example, all of the software updates for the product since the last service pack or product version release.

A large installed base of customers is typically serviced via telephone call system support, and via software updates delivered via the Internet. Applicant has appreciated that an attack causing damage in a substantial portion of the installed base can be difficult to remedy via conventional means due to the large volume of support calls, the complexity of the diagnosis and the remediation advice, and the dependency on information collection and/or distribution via the Internet. A virus attack in some situations, can damage a computer's ability to communicate via the Internet to support remediation of damage. To minimize the threat of security vulnerabilities, the latest software updates should be obtained and deployed as quickly and efficiently as possible. Effective distribution of patches related to security problem update needs, and other update needs, can be impaired, however, by present distribution methods and by deficient customer awareness of the availability of a desirable patch.

Applicant has appreciated that a remotely managed kiosk can effectively support distribution of software patches for a computer's pre-existing software to remedy some deficiencies in some prior methods for patch distribution. These kiosks can be located, for example, in facilities commonly visited by customers of a software vendor on a daily basis, such as shopping centers, retail chains, grocery stores, banks, and government and educational facilities. The kiosks can also be used to advertise patch availability, and to warn the population of virus alerts while providing on-demand physical media to prevent and/or recover from a problem.

Software patches that can be distributed via the kiosks include, for example, those that upgrade a program, those that eliminate a security vulnerability, those that rescue a damaged program, etc. The kiosk can be an effective distribution tool when, for example, Internet communications are disrupted, or a broadband connection is unavailable.

Some embodiments of the invention involve methods for distributing software patches to customers via kiosks at convenient locations (e.g., at locations frequented by the customers), wherein the kiosks with the patches on at least one portable computer recordable medium. The customer can then load the patch from the portable medium to their computer in any suitable way. For example, the portable medium can be physically transported to the computer and loaded directly thereon, thereby eliminating the use of a network connection and/or telephone voice communication to implement a patch installation. Of course, the patch can alternatively be transferred from the media to the computer via a network or telephone connection, as the invention is not limited in this respect.

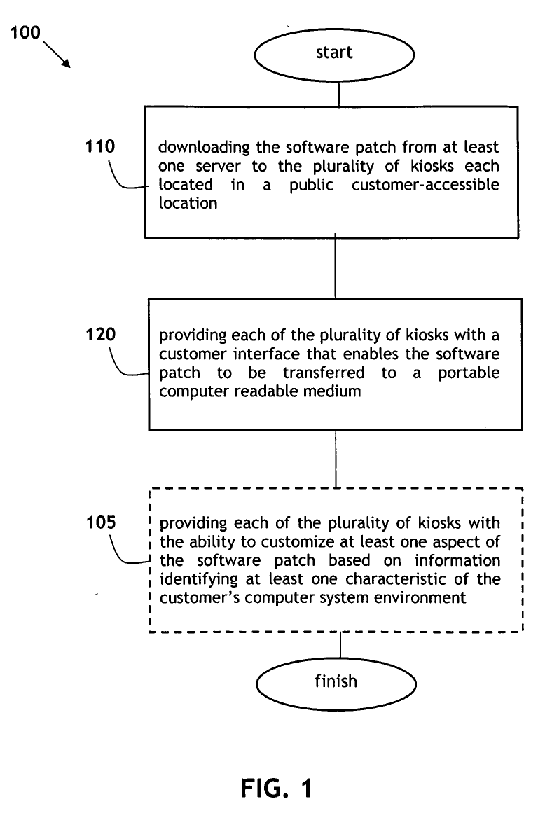

FIG. 1 is a flow diagram of a method 100 for distributing a software patch to a plurality of customers, according to one embodiment of the invention. The method 100 includes the acts of downloading 110 the software patch from at least one server to one or more kiosks each located in a public customer-accessible location, and providing 120 each of the plurality of kiosks with a customer interface that enables the software patch to be transferred to a portable computer readable medium. The kiosks can be used to create a copy of the software patch on the portable computer readable medium, which can then be used to load the patch on a customer's computer as described above.

The software patch includes software designed to modify at least one pre-existing software program the act of providing 105 each of the kiosks with the ability to customize at least one aspect of the software patch to be transferred to the portable computer readable medium for the customer based on the information identifying at least one characteristic of the customer's computer system environment on which the software patch can be implemented.

A software patch may modify a pre-existing program by, for example, performing any one or a combination of the following functions: adding features to the pre-existing program; repairing the pre-existing program; replacing the pre-existing program; and updating portions of the pre-existing program (for example, updating information, adding new virus definitions, etc.) For example, a customer's computer that requires recovery from an attack may best be repaired by rebuilding a fresh system. Without a fresh rebuild, there is a danger, for example, that back doors—placed on the computer during an attack—will remain (for example, several viruses leave back doors for future exploits). Thus, a patch can be used to reinstall the operating system, to reload applications, and/or to ensure that an exploited vulnerability has been corrected.

The kiosks can be, for example, operated by and/or provided by a vendor of software related to the software patch, or by any other entity. The kiosks can be located at any location that is accessible to customers. For example, the kiosks can be located at retail outlets such as department stores, consumer electronics stores, grocery stores, banks, or in any other suitable location.

The portable computer readable medium can include any suitable type of media. For example, the media can include any one or a combination of the following types: CD, Digital Versatile Disk (DVD), removable magnetic disk, Universal Serial Bus (USB) memory key, and hard disk drive media, or any other type. The kiosk can include a supply of the portable media and/or a customer can provide the medium. A patch can be loaded into one or disk array multiple media.

The software patch can be stored in a computer readable medium for later transfer to the portable computer readable medium. For example, a kiosk can include a hard disk drive for storage of a patch. Alternatively, the computer readable medium can be located external to the kiosk.

The portable readable medium can be separate from or included in a customer's computer. For example, if the computer is a portable computer, the customer can bring the computer to a kiosk location. The kiosk can be configured to deliver the software patch directly to a medium or the portable computer, such as the hard drive, other memory component or other medium.

To permit delivery to a portable computer, the software patch can be transferred in any suitable way, such as via, wireless communications (e.g., Wi-Fi, Worldwide Interoperability for Microwave Access (WiMAX), or bluetooth), a temporary wired connection to the kiosk (e.g., a USB port) or any other suitable way.

In one embodiment, to facilitate delivery of a patch, the customer interface of the kiosks can be configured to receive information identifying at least one characteristic of a customer's computer system environment on which the software patch is to be installed, and the method 100 can include the act of providing 105 each of the kiosks with the ability to customize at least one aspect of the software patch to be transferred to the portable computer readable medium for the customer based on the information identifying at least one characteristic of the customer's computer system environment on which the software patch can be implemented. Thus, information about a customer's computer can facilitate selection of a patch tailored to the particular needs of a customer's computer.

The characteristics of the customer's computer system environment can include any suitable information, for example, such information can include information that enables a kiosk to determine what (if any) software updates have already been installed on the computer, information concerning the version and/or build of the operating system, information about other existing programs, and/or information about an existing patch state, information about the computer's hardware configuration, etc.

In one embodiment, the information provided to the kiosk may include an identifier of the customer's computer, such as the computer's operating system's unique product identifier, or other identifier. If the customer supplies the kiosk with such an identifier, the method 100 can further include an act of downloading state information associated with the software environment of the computer, and selecting the software patch in response to the state information. To make state information of a customer's computer available for download, a software vendor can, for example, collect state information from the customer's computer to facilitate a later need for that information. The information can be stored in a manner accessible to a server that downloads the patch to the kiosk, for example, in a networked storage device maintained by the software vendor. A customer can thus obtain a desired and/or needed patch even if the customer can directly provide to the kiosk no other information than, for example, an identifier of his/her computer.

The information can be transferred from a customer to a kiosk in a variety of ways. For example, though not required, a kiosk can be configured so that a customer can bring an original installation CD for reading by the kiosk. In this example, the kiosk can be configured to scan a hologram on the CD to verify the product installation identity, if desired, and can determine what build and version of the operating system (OS) was originally installed to help tailor, for example, a software update to be stored on a CD portable medium.

In an alternative embodiment of the method 100, a menu driven system configured as part of the kiosk interface can receive information about a customer's computer by collecting responses from the customer. As another alternative, a vendor can provide Internet-based facilities for creation of encoded information extracted from a computer. For example, the vendor's Web site and/or a Internet-based update facility provided by the vendor for an operating system can be modified to include features allowing customers to create an encoded description of their computer configuration. Encoded information can be stored, for example, as a 2-dimensional bar code printed on paper for reading by a barcode scanner included in a kiosk, or in any other suitable manner.

In contrast to conventional methods for distributing patches, the method 100 can thus provide a patch on a portable storage medium in response to information provided to the kiosk about a computer's software environment. Thus, for example, a kiosk can provide a patch tailored with a specific security configuration instead of a standard base configuration. It should be appreciated that while the ability to customize a patch based upon information provided to the kiosk provides the advantages discussed above, it is not necessary to all embodiments of the invention; the kiosk can be used to provide a patch that is not customized based upon information provided by a customer In one embodiment, the method 100 can be used to deliver a patch including, for example, interventional tools (e.g., software scripts) which when executed on the customer's computer will achieve a specific configuration with known security characteristics, e.g., similar to what is done via logon scripts and group policies within an enterprise network. One advantage of the delivery of a script on a portable medium (e.g., a CD), is that the script can be guaranteed to be authentic (issued, for example, from a trusted vendor) and that script delivery requires no Internet connection, and requires little if any customer interaction.

The kiosk can include a computing device to support the above-described features of the method 100, and to support communication with a software update server that downloads the patches(es) to the kiosk. The computing device can take any suitable form, as the invention is not limited in this respect. For example, the computing device can include at least one processing unit and memory supporting the processing unit. Depending on the configuration and type of computing device, memory may be, for example, volatile (such as RAM), non-volatile (such as ROM, flash memory, etc.) or some combination of the two.

The device may include additional storage (removable and/or non-removable) including, but not limited to, magnetic or optical disks or tape. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can accessed by a computer medium device. Any such computer storage media may be part of the computer device.

The kiosk can have a communications connection(s) to support communication via a communications medium between the kiosk and one or more software update servers. By way of example, and not limitation, optional communication media include wired media such as a wired network or direct-wired connection, and wireless media such as acoustic, RF, infrared and other wireless media. Can use publically available network (e.g., the internet), a private network or any other suitable communication facility.

The kiosk may have any suitable customer interface. For example, the kiosk may include an input device(s) such as keyboard, mouse, pen, voice input device, touch input device, etc. The device may include output device(s) to support customer interactions, output devices can include, for example, a display, speakers, printer, etc.

Another method, according to one embodiment of the invention, provides distribution of programs via a kiosk. This method provides distribution when, for example, a customer's computer has an impaired network connection. For example, the appearance of spyware on a customer's computer can compromise an Internet connection of the computer. In response to this problem, a spyware-removal program can be distributed via a kiosk. A customer can obtain the spyware-removal program, in a manner similar to that described above for patch distribution. Once loaded on the user's affected computer, the program can repair the operability of existing software on the computer.

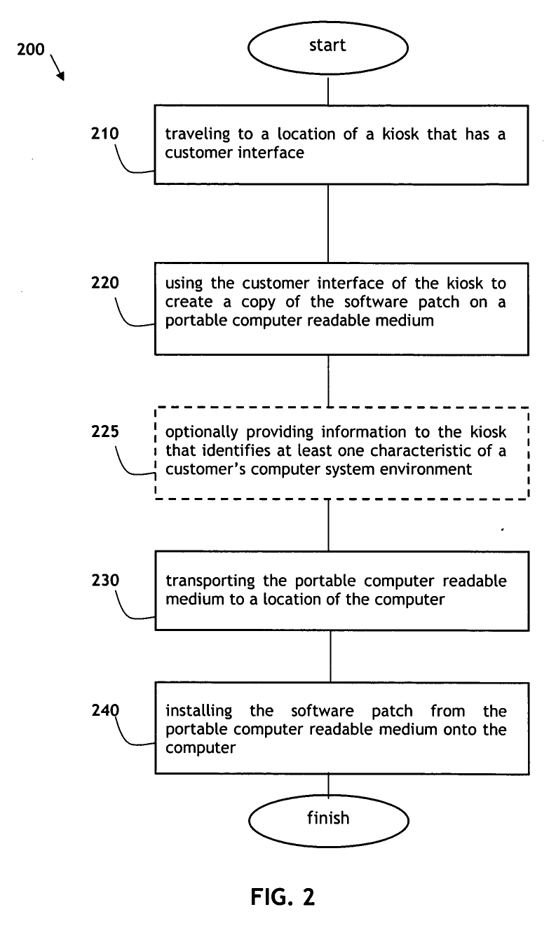

FIG. 2 is a flow diagram of a method 200 for updating a computer to install a software patch applicable to at least one software program previously installed on the computer, according to one embodiment of the invention. The method 200 can be implemented by, for example, an owner of the computer. The method 200 includes the acts of 210 traveling to a location of a kiosk, using 220 the kiosk customer interface to create a copy of the software patch on a portable computer readable medium, transporting 230 the portable computer readable medium to a location of the computer, and installing 240 the software patch from the portable computer readable medium onto the computer. The kiosk and computer readable medium can be implemented in any of the manners discussed above.

One may travel to a location having a kiosk in response to, for example, a disruption in network-based communications of the computer. For example, if a software patch is required to remedy a software-related problem (e.g., resulting from a virus) that disrupts patch distribution via Internet-based communications, the method 200 permits receipt a patch to the impaired computer via a distribution scheme that is not dependent upon the impaired computer's ability to access the internet.

The method 200 can also optionally include an act of providing 225 information to the kiosk that identifies at least one characteristic of a customer's computer system environment on which the software patch can be implemented. Thus, like the method 100, the method 200 can entail use of information about the computer system environment to select an appropriate patch for receipt by a customer.

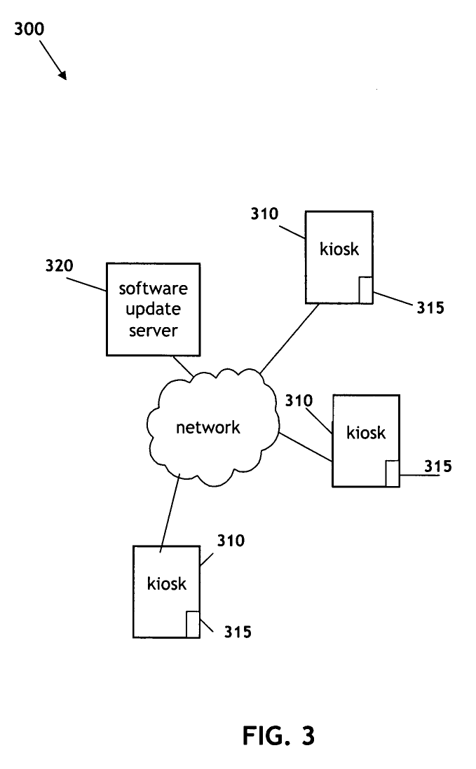

FIG. 3 is a block diagram of an embodiment of a system 300 for distributing a software patch to customers in accordance with one embodiment of the invention. The system 300 includes a plurality of kiosks 310 and at least one software update server 320. The system 300 can be used to implement, for example, the methods 100, 200. While 3 kiosks and one software update server are shown, the invention is not limited in this respect, as there can be any number of either.

The kiosks 310 are located in public customer-accessible locations. The kiosks include a customer interface 315 that enables the software patch to be transferred to a portable computer readable medium so that customers can use at least one of the kiosks to create a copy of the software patch on the portable computer readable medium in any of the manners discussed above. The at least one server 320 is configured to download the software patch to the kiosks.

In one embodiment, the customer interface 315 optionally can be configured to receive information about the state of a computer's software environment in any of the ways described above with reference to the methods 100, 200.

In one embodiment, each kiosk 310 can include, for example, a computer-controlled CD burner and CD dispenser (when CDs are used as the portable media), input keyboard, mouse, touch screen, etc. for customers to enter selection information. In one embodiment, each kiosk may include a printout interface, which can include ability to accept credit/debit cards, cash and make change, etc. but the invention is not limited in this respect as the kiosks alternatively can be used to provide free software patches and a change making device for handling change and small denominations of bills.

Communication between the kiosks 310 and the server 320 can be accomplished using any of the techniques described above. Kiosks 310 can have access panels to permit, for example, reloading of CD blanks, servicing of, and removal of cash, repairs, etc.

The distribution software system 300 can include a computing device running any suitable software to facilitate the downloading of patches from the sever 320 to the kiosks 315. For example, a modified version of the “WINDOWS” operating system update utility and/or the “OFFICE” productivity software update utility currently provided by Microsoft Corporation (Redmond, Wash.) via the Internet can be employed. These utilities could be modified to run locally on the customer's computer, for example, from the computer's CD drive. Patch software images can be distributed using a staging server network including the server 320. Software patch reference images created by a software vendor can thus be directed to the server 320, and forwarded to the kiosks 310. Patches can be retained on the kiosk 310, and can be updated on demand from a master site via the server 320.

The server 320 can be of any type suitable to delivery of patches. For example, the server 320 can be a Systems Management Server (SMS) available from Microsoft Corporation (Redmond, Wash.). Such a server 320 can deploy and manage the distribution of software updates to a large number of kiosks 310. In one embodiment, the server 320 can perform at least some of the following functions: inventory functions, in response to customer computer information, to identify which software applications and software updates have been installed and which need to be installed on the deployed computers; scheduling functions that allow patches to be delivered to kiosks 310 outside regular business hours, and status reporting that allows administrators to monitor kiosk 310 activity.

The server 320 can also support, for example, Software Update Services available from Microsoft Corporation (Redmond, Wash.) This utility can be used to provide dynamic notification of updates to kiosks 320, and to support automatic distribution updates to the kiosks 320.

The server 320 can be configured to support retrieval of the latest critical updates from, for example, the “WINDOWS” operating system update utility. As new updates are added to this utility, the server 320 can be configured to automatically download and store them at the kiosks, based on an administrator-defined schedule. Alternatively, the downloads can be initiated manually, or can be requested by a kiosk 310.

The above-described methods 100, 200 can be implemented in any of numerous ways. For example, the methods 100, 200 can be implemented on the system 300. More generally, for example, the methods 100, 200 may be implemented, at least in part, using hardware, software or a combination thereof. When implemented in software, the software code can be executed on any suitable processor or collection of processors, whether provided in a single computer or distributed among multiple computers.

It should be appreciated that some features of the methods 100, 200 outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

It should be understood that the term “program” is used herein in a generic sense to refer to any type of computer code or set of instructions that can be employed to program a computer or other processor to implement various aspects of the present invention as discussed above, and is not limited to any application program. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. In particular, each of the top-level activities may include any of a variety of sub-activities. For example, the top-level activities described herein may include one or any combination of sub-activities described herein or may include other sub-activities that refine the hierarchical structure of instructing and administering a patch management process.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method for distributing a software patch to a plurality of customers, the method comprising acts of:
(A) downloading the software patch from at least one server to a plurality of kiosks each located in a public customer-accessible location, wherein the software patch comprises software designed to modify at least one pre-existing software program; and
(B) providing each of the plurality of kiosks with a customer interface that enables the software patch to be transferred to portable computer readable media so that each of the plurality of customers can use at least one of the plurality of kiosks to create a copy of the software patch on at least one portable computer readable medium.

2. The method of claim 1, wherein the act (B) comprises an act of providing the plurality of kiosks in retail outlets.

3. The method of claim 1, wherein the act (B) comprises an act of providing each of the plurality of kiosks with a plurality of portable computer readable media.

4. The method of claim 1, wherein the customer interface also enables each of the plurality of kiosks to receive information identifying at least one characteristic of a customer's computer system environment on which the software patch will be implemented.

5. The method of claim 4, further comprising an act of:
(C) providing each of the plurality of kiosks with the ability to customize at least one aspect of the software patch to be transferred to the portable computer readable medium for the customer based on the information identifying at least one characteristic of the customer's computer system environment on which the software patch will be implemented.

6. The method of claim 4, wherein the at least one characteristic is associated with an operating system of the customer's computer system environment.

7. The method of claim 4, wherein the at least one characteristic is further associated with an existing patch state of the customer's computer system environment.

8. The method of claim 1, wherein the software patch is designed to address a security vulnerability in the at least one pre-existing software programed.

9. The method of claim 1, wherein the software patch is further designed to correct any damage done via an exploitation of the security vulnerability.

10. The method of claim 1, wherein the act (B) comprises providing each of the plurality of kiosks with an indicator that notifies customers that a security patch is available to remedy a security vulnerability.

11. A method of updating a computer by installing a software patch applicable to at least one software program previously installed on the computer, the method comprising acts of:
(A) traveling to a location of a kiosk that has the software patch stored in a computer readable medium accessible thereto and a customer interface that enables the software patch to be transferred to portable computer readable media;
(B) using the customer interface to create a copy of the software patch on at least one portable computer readable medium;
(C) transporting the at least one portable computer readable medium to a location of the computer; and
(D) installing the software patch from the at least one portable computer readable medium onto the computer.

12. The method of claim 11, wherein the act (A) comprises traveling to the location of the kiosk in response to a disruption in network-based communications of the computer.

13. The method of claim 11, wherein the kiosk has a plurality of portable computer readable media.

14. The method of claim 11, further comprising an act of (E) providing information to the kiosk that identifies at least one characteristic of the computer.

15. The method of claim 14, wherein the at least one characteristic is associated with an operating system and an existing patch state of the computer.

16. The method of claim 11, wherein the software patch is designed to address a security vulnerability in the at least one pre-existing software program, and to correct any damage done via an exploitation of the security vulnerability.

17. The method of claim 11, further comprising the act (E) of receiving an indicator from the kiosk that a security patch is available to remedy a security vulnerability.

18. A system for distributing a software patch to a plurality of customers, comprising:
a plurality of kiosks each located in a public customer-accessible location, and each having a customer interface that enables the software patch to be transferred to portable computer readable media so that each of the plurality of customers can use at least one of the plurality of kiosks to create a copy of the software patch on the portable computer readable medium; and
at least one server configured to download the software patch to the plurality of kiosks, wherein the software patch comprises software designed to modify at least one pre-existing software program.

19. The method of claim 18, wherein the customer interface also enables each of the plurality of kiosks to receive information identifying at least one characteristic of a customer's computer system environment on which the software patch can be implemented.

20. The system of claim 19, wherein the customer interface comprises a barcode scanner to scan a barcode associated with the information.
